(19) United States
(12) Patent Application Publication
(10) Pub. No.: US 2014/0286163 A1
(43) Pub. Date: Sep. 25, 2014

(54) DATA CHANNEL SCHEDULING METHOD AND SYSTEM FOR ORTHOGONAL FREQUENCY DIVISION MULTIPLEXING ACCESS (OFDMA)-BASED WIRELESS MESH NETWORK

(71) Applicant: INTELLECTUAL DISCOVERY CO., LTD., Seoul (KR)

(72) Inventor: Suk Chan KIM, Busan (KR)

(73) Assignee: INTELLECTUAL DISCOVERY CO., LTD., Seoul (KR)

(21) Appl. No.: 14/224,934

(22) Filed: Mar. 25, 2014

(30) Foreign Application Priority Data
Mar. 25, 2013 (KR) 10-2013-0031553

(51) Int. Cl. H04W 28/02

(52) U.S. Cl. CPC H04W 28/0252
USPC 370/230.1

(57) ABSTRACT

Provided is a data channel scheduling system for an orthogonal frequency division multiplexing access (OFDMA)-based wireless mesh network, the system including a set classifying unit to classify a plurality of nodes included in the OFDMA-based wireless mesh network, into multiple requests allowing sets based on a preset reference, and an information providing unit to provide information on the classified sets such that multiple requests are performed on one of the classified multiple requests allowing sets.

### CROSS-REFERENCE TO RELATED APPLICATION

This application claims the priority benefit of Korean Patent Application No. 10-2013-0031553, filed on Mar. 25, 2013, in the Korean Intellectual Property Office, the disclosure of which is incorporated herein by reference.

### BACKGROUND

1. Field of the Invention

The present invention relates to a method and system for scheduling a data channel in an orthogonal frequency division multiplexing access (OFDMA)-based wireless mesh network.

2. Description of the Related Art

To support a mesh network, a time division multiple access (TDMA)-based mesh mode is included in an Institute of Electrical and Electronics Engineers (IEEE) 802.16 standard. Two scheduling schemes including a centralized scheduling and a distributed scheduling are defined in an IEEE 802.16 mesh mode. The centralized scheduling may be a management scheme for a base station (BS) node to schedule all nodes. The distributed scheduling may be a scheme in which each node performs a scheduling of a corresponding node without the BS node.

However, in an IEEE 802.16 mesh scheme, since a TDMA-based physical layer is used, a scheduling delay time may be relatively long and resource efficiency may be relatively low. To solve this, a wireless mesh network method of using an OFDMA as a physical layer is suggested.

FIG. 1 is a diagram illustrating a frame configuration of an orthogonal frequency division multiplexing access (OFDMA)-based wireless mesh network according to a related art. FIGS. 2A and 2B are diagrams illustrating a three-way handshaking process for a distributed scheduling in an OFDMA-based wireless mesh network according to a related art.

Referring to FIG. 1, in a frame configuration of the OFDAM-based wireless mesh network, a time slot based on an existing time division multiple access (TDMA) scheme may be divided into a number of sub-channels on a frequency and thus, a scheduling delay time of a control channel may be reduced and resource utilization efficiency of a data channel may be improved. Here, a distributed scheduling (DSCH) is a subframe for transmitting a distributed scheduling message, and a DATA may indicate a subframe for data transmission. The DSCH may include K sub-channels and the DATA may include L sub-channels. Here, K is a natural number and L is a natural number.

Referring to FIGS. 2A and 2B, a node including data to be transmitted in the OFDMA-based wireless mesh network, that is, a request node may reserve resources of a neighboring node through a three-way handshaking process.

For example, the request node may request a data slot to the neighboring node using a request message at a DSCH transmission time of the request node. A grant node receiving a request for resources from the request node may determine an area of resources to be allocated to the request node, and transmit, to the request node, information on the resource determined to be allocated, using a grant message at a DSCH transmission time of the grant node. When the request node receives the grant message, the request node may transmit a confirmation message to the grant node at a subsequent DSCH transmission time of the request node, and complete a resources reservation.

In FIG. 2B, each of a node A and a node C may indicate the request node, and a node B may indicate the grant node. As described in FIG. 2B, when the node A transmits a request message R1 to the node B using a sub-channel 1, and the node C transmits a request message R2 to the node B using a sub-channel 2, the node B receiving the request message

R1 and the request message R2 may transmit a grant message G1 and a grant message G2 to the node A and the node B using the sub-channel 1 and the sub-channel 2, respectively.

However, when the node A and the node C are in a two-hop relationship, the node C may not receive the grant message of the node A and thus, a collision may occur between grant resources of the node C and the node A.

Accordingly, there is a desire for a method of preventing a collision occurring between the grant resources when a request is performed to multiple nodes in an OFDMA-based distributed scheduling scheme, and allocating data resources to an increased number of nodes in comparison to an existing scheme.

### SUMMARY

An aspect of the present invention provides a data channel scheduling method and system for an orthogonal frequency division multiplexing access (OFDMA)-based wireless mesh network in order to prevent a collision occurring when a request is performed to multiple nodes in an OFDMA-based distributed scheduling scheme.

Another aspect of the present invention also provides a data channel scheduling method and system for an OFDMA-based wireless mesh network in order to allocate data resources to an increased number of nodes in comparison to an existing scheme.

According to an aspect of the present invention, there is provided a data channel scheduling system for an OFDMA-based wireless mesh network, the system including a set classifying unit to classify a plurality of nodes included in the OFDMA-based wireless mesh network, into multiple requests allowing sets based on a preset reference, and an information providing unit to provide information on the classified sets such that multiple requests are performed on one of the classified multiple requests allowing sets.

The set classifying unit may classify nodes in a one hop relationship among the nodes, as a multiple requests allowing set.

The multiple requests allowing set may be a set of nodes, each having a different scheduling message transmission time.

The nodes may perform multiple requests by selecting one of the multiple requests allowing sets based on a preset data scheduling policy.

The data scheduling policy may be a policy for minimizing a packet delay time.

According to another aspect of the present invention, there is also provided a node configuring an OFDMA-based wireless mesh network, the node including a selecting unit to select a multiple requests allowing set to perform multiple requests through the OFDMA-based wireless mesh network based on information associated with multiple requests allowing sets classified based on a preset reference, and a transmitting and receiving unit to transmit a request message requesting resources to each node included in the selected multiple requests allowing set.

According to still another aspect of the present invention, there is also provided a data channel scheduling method of an orthogonal frequency division multiplexing access (OFDMA)-based wireless mesh network, the method including classifying, by a data channel scheduling system, a plurality of nodes configuring the OFDMA-based wireless mesh network, into multiple requests allowing sets based on a preset reference, and providing information on the classified multiple requests allowing sets such that multiple requests are performed on one of the classified multiple requests allowing sets.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a frame configuration of an orthogonal frequency division multiplexing access (OFDMA)-based wireless mesh network according to a related art;

FIGS. 2A and 2B are diagrams illustrating a three-way handshaking process for a distributed scheduling in an OFDMA-based wireless mesh network according to a related art;

FIGS. 3A through 3C are diagrams illustrating an example of a collision occurring in data resources granted when multiple requests are performed in an OFDMA-based wireless mesh network according to a related art;

FIG. 4 is a diagram illustrating a data channel scheduling method of an OFDMA-based wireless mesh network according to an embodiment of the present invention;

FIG. 5 is a block diagram illustrating a data channel scheduling system for an OFDMA-based wireless mesh network according to an embodiment of the present invention;

FIG. 6 is a block diagram illustrating a node configuring an OFDMA-based wireless mesh network according to an embodiment of the present invention; and

FIG. 7 is a flowchart illustrating a data channel scheduling method of an OFDMA-based wireless mesh network according to an embodiment of the present invention.

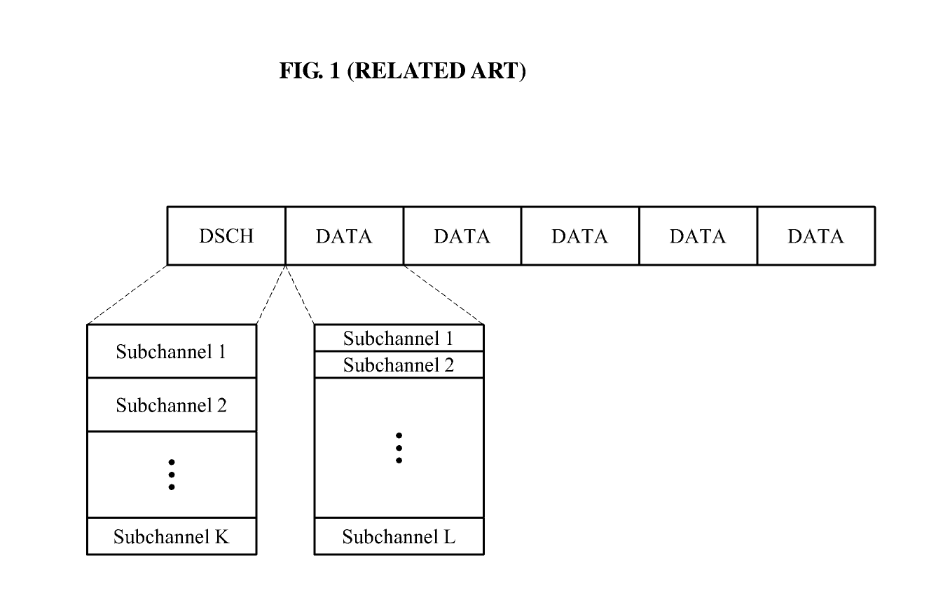

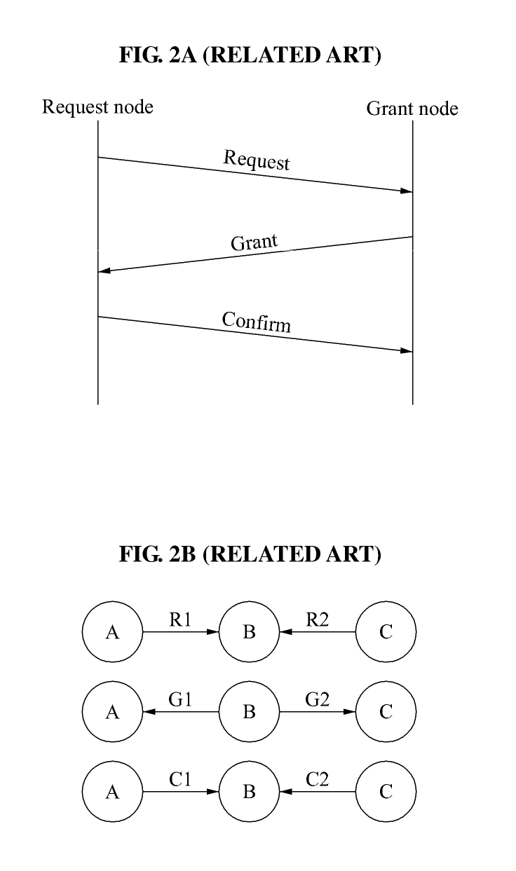

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

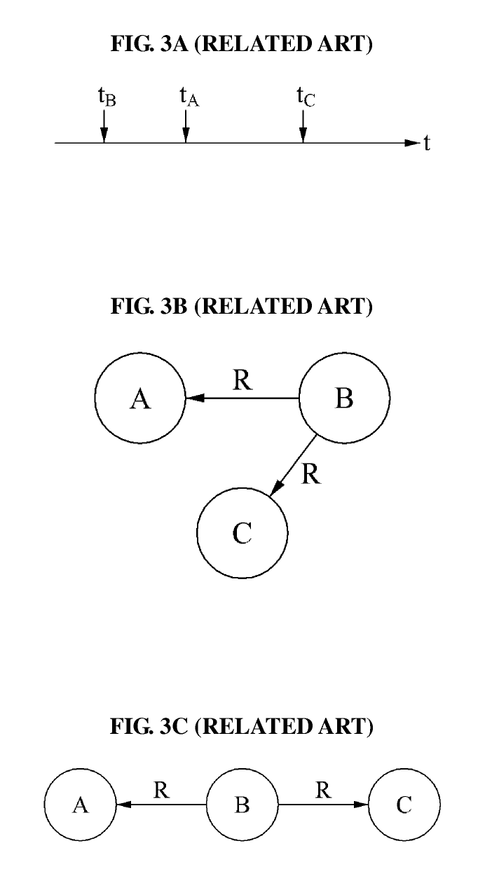

FIGS. 3A through 3C are diagrams illustrating an example of a collision occurring in data resources granted when multiple requests are performed in an OFDMA-based wireless mesh network according to a related art. Referring to FIGS. 3A through 3C, in the OFDMA-based wireless mesh network, a node B may transmit a request message requesting resources, to each of a node A and a node C. A scheduling message transmission time of each of the node A, the node B, and the node C may be assumed to be t_{B}<t_{A}<t_{C} with reference to FIG. 3A. Here, the scheduling message transmission time may indicate a point in time at which a scheduling message is transmitted.

In this example, referring to FIG. 3B, when the node A and the node C are in a one-hop relationship, the node may receive, from the node C, a grant message of the node C in response to a request message R of the node B, and the node C may receive, from the node A, a grant message of the node A in response to the request message R of the node B. Thus, when the node C grants remaining resources, aside from data resources granted by the node A, a collision may not occur between resources granted by the node A and resources granted by the node A.

However, referring to FIG. 3C, when the node A and the node A are in a two-hop relationship, the node C may not receive the grant message of the node A and thus, the collision may occur between the resource granted by the node A and the resource granted by the node C.

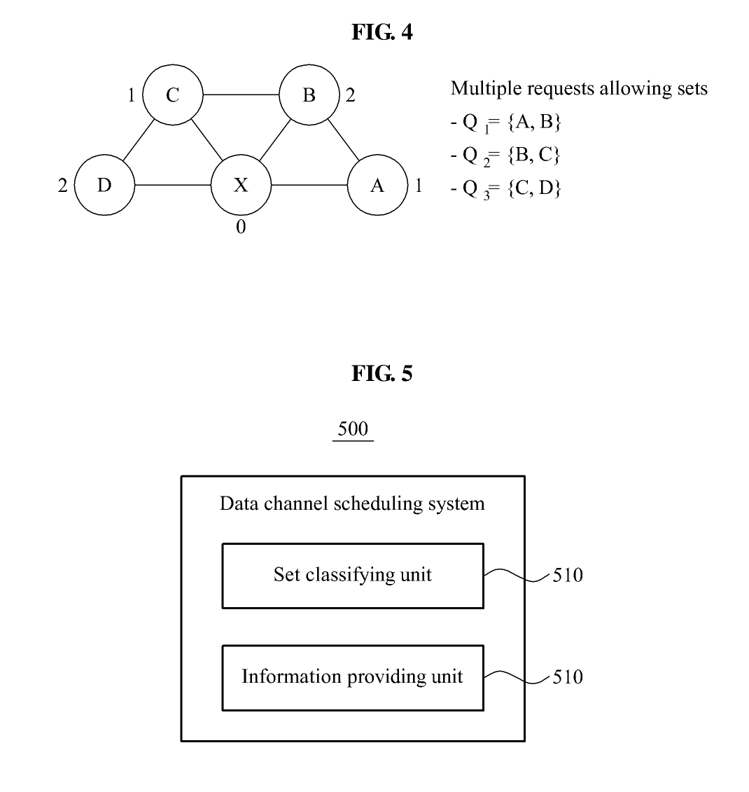

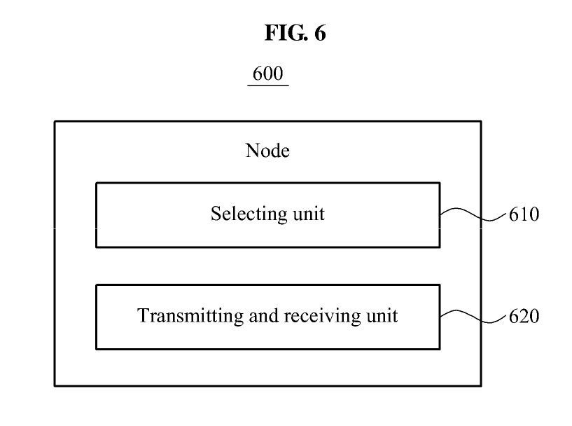

FIG. 4 is a diagram illustrating a data channel scheduling method of an OFDMA-based wireless mesh network according to an embodiment of the present invention.

In an OFDMA-based distributed scheduling scheme, as described above, when a request node requests data resources from at least two nodes, a collision may occur in granted data resources in a case in which grant nodes are in a two-hop relationship. Thus, in the data channel scheduling method of the OFDMA-based wireless mesh network according to an example embodiment, neighboring nodes may be classified into multiple requests allowing sets in advance such that one of the multiple requests allowing sets performs multiple requests, thereby avoiding a collision in grant resources in a requesting operation. To this end, nodes configuring a multiple requests allowing set may need to satisfy two conditions below.

One condition may indicate that the nodes need to be in a one-hop relationship. Another condition may indicate that a scheduling message transmission time may need to be different for each of the nodes. For example, as described in FIG. 4, when a node X is a request node and each of a node A, a node B, a node C, and a node D is a grant node, multiple request allowing sets of the node X may be classified as Q1={A, B}, Q2={B, C}, and Q3={C, D}. In FIG. 4, lines among the nodes may indicate that the nodes are in the one-hop relationship, and a number placed adjacent to each of the nodes may indicate a point in time at which a grant message is transmitted.

In this example, the node X may perform multiple requests by selecting one of the multiple requests allowing sets Q1, Q2, and Q3 based on a preset data scheduling policy.

For example, when the node X applies a policy for minimizing a packet delay time as the data scheduling policy, and an average packet delay time of the node A, an average packet delay time of the node B, an average packet delay time of the node C, and an average packet delay time of the node D correspond to 10, 20, 15, and 5, respectively, the node X may perform the multiple requests on Q2 having the longest average packet delay time.

FIG. 5 is a block diagram illustrating a data channel scheduling system 500 for an OFDMA-based wireless mesh network according to an embodiment of the present invention. Hereinafter, descriptions about the data channel scheduling system 500 according to an example embodiment will be provided with reference to FIG. 5.

Referring to FIG. 5, the data channel scheduling system 500 may include a set classifying unit 510 and an information providing unit 520.

The set classifying unit 510 may classify a plurality of nodes configuring the OFDMA-based wireless mesh network, into multiple requests allowing sets based on a preset reference.

As an example, to prevent a collision between grant resources occurring when request messages are transmitted to the plurality of nodes, the set classifying unit 510 may classify nodes that are in a one-hop relationship among the plurality of nodes configuring the OFDMA-based wireless mesh network into the multiple requests allowing sets. In this example, the set classifying unit 510 may classify nodes, each having a different scheduling message transmission time as a multiple requests allowing set.

The information providing unit 520 may provide information associated with the multiple requests allowing sets such that the multiple requests are performed on one of the multiple requests allowing sets classified by the set classifying unit 510.

Accordingly, a node receiving the information associated with the multiple requests allowing sets may perform the multiple requests by selecting one of the multiple requests allowing sets based on a preset data scheduling policy, thereby performing a collision-free scheduling. Here, the data scheduling policy may be, for example, a policy for minimizing a packet delay time.

FIG. 6 is a block diagram illustrating a node 600 configuring an OFDMA-based wireless mesh network according to an embodiment of the present invention.

Referring to FIG. 6, the node 600 configuring the OFDMA-based wireless mesh network may include a selecting unit 610 and a transmitting and receiving unit 620.

The selecting unit 610 may select a multiple requests allowing set to perform multiple requests through an OFDMA based on information associated with multiple requests allowing sets classified based on a preset reference. In this example, the multiple requests allowing sets may be in a one-hop relationship with each other and may be a set of nodes, each having a different a scheduling message transmission time.

As an example, the selecting unit 610 may select one of a plurality of multiple requests allowing sets based on a preset data scheduling policy. In this example, the preset data scheduling policy may be, for example, a policy for minimizing a packet delay time.

The transmitting and receiving unit 620 may transmit a request message requesting resources to each node included in the multiple requests allowing set selected by the selecting unit 610.

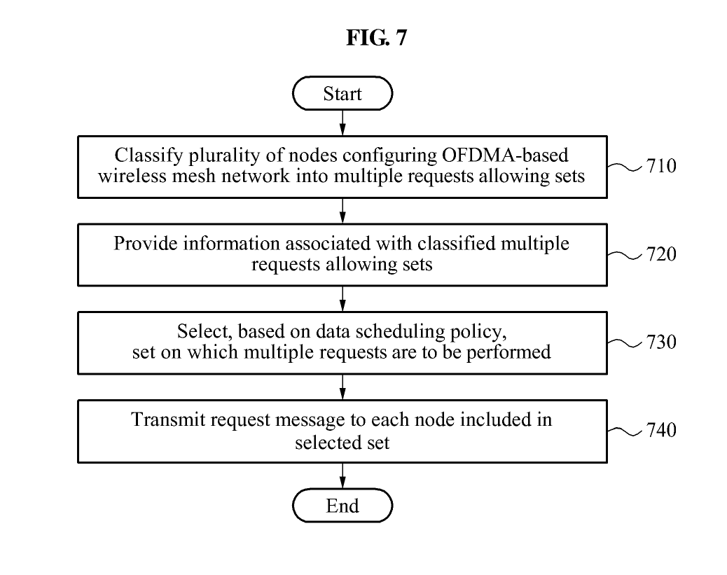

FIG. 7 is a flowchart illustrating a data channel scheduling method of an OFDMA-based wireless mesh network according to an embodiment of the present invention.

Hereinafter, descriptions about a process in which a data channel scheduling system according to an example embodiment performs a scheduling will be provided with reference to FIG. 7.

In operation 710, for a collision-free distributed scheduling, the data channel scheduling system may classify a plurality of nodes configuring the OFDMA-based wireless mesh network into multiple requests allowing sets based on a preset reference. In this example, the data channel scheduling system may classify nodes in a one-hop relationship, each having a different scheduling message transmission time, into a multiple requests allowing set.

In operation 720, information associated with the multiple requests allowing sets may be provided to a node included in the OFDMA-based wireless mesh network such that multiple requests are performed on one of the classified multiple requests allowing sets.

In operation 730, when the node receiving the information associated with the multiple requests allowing sets may select one of the multiple requests allowing sets based on a preset data scheduling policy. In this example, the preset data scheduling policy may be, for example, a policy for minimizing a packet delay time. In operation 740, a request message may be transmitted to each of the nodes included in the classified multiple requests allowing set to request resources.

In the wireless mesh network using the OFDMA-based distributed scheduling scheme, a base station or a relay station may not be required in contrast to an existing mobile communication network. Thus, the wireless mesh network using the OFDMA-based distributed scheduling scheme may provide a high cost efficiency for building a network, and an ease for expanding the network. Accordingly, when the data channel scheduling method and system for the OFDMA-based wireless mesh network according to an example embodiment is applied to a backbone communication network of a region requiring a wired and wireless network infrastructure, or a communication network used for a public safety such as police officers, a firefighters, emergency medical services, and the like, an enhanced performance may be provided.

According to an aspect of the present invention, it is possible to prevent a collision between grant resources occurring when a request is performed to multiple nodes, by classifying a plurality of nodes included in an OFDMA-based wireless mesh network into multiple requests allowing sets such that the multiple requests are performed on one of the multiple requests allowing sets.

According to another aspect of the present invention, it is possible to increase a transmission rate of a mesh network since data resources may be allocated to an increased number of nodes in comparison to an existing scheme.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A data channel scheduling system for an orthogonal frequency division multiplexing access (OFDMA)-based wireless mesh network, the system comprising:
a set classifying unit to classify a plurality of nodes included in the OFDMA-based wireless mesh network, into multiple requests allowing sets based on a preset reference; and
an information providing unit to provide information on the classified sets such that multiple requests are performed on one of the classified multiple requests allowing sets.

2. The system of claim 1, wherein the set classifying unit classifies nodes in a one hop relationship among the nodes, as a multiple requests allowing set.

3. The system of claim 2, wherein the multiple requests allowing set is a set of nodes, each having a different scheduling message transmission time.

4. The system of claim 1, wherein the nodes perform multiple requests by selecting one of the multiple requests allowing sets based on a preset data scheduling policy.

5. The system of claim 4, wherein the data scheduling policy is a policy for minimizing a packet delay time.

6. A node configuring an orthogonal frequency division multiplexing access (OFDMA)-based wireless mesh network, the node comprising:
a selecting unit to select a multiple requests allowing set to perform multiple requests through the OFDMA-based wireless mesh network based on information associated with multiple requests allowing sets classified based on a preset reference; and
a transmitting and receiving unit to transmit a request message requesting resources to each node included in the selected multiple requests allowing set.

7. The node of claim 6, wherein the multiple requests allowing sets are sets of nodes in a one-hop relationship, each having a different scheduling message transmission time.

8. The node of claim 6, wherein the selecting unit selects one of the multiple requests allowing sets based on a preset data scheduling policy.

9. The node of claim 6, wherein the data scheduling policy is a policy for minimizing a packet delay time.

10. A data channel scheduling method of an orthogonal frequency division multiplexing access (OFDMA)-based wireless mesh network, the method comprising:
classifying, by a data channel scheduling system, a plurality of nodes configuring the OFDMA-based wireless mesh network, into multiple requests allowing sets based on a preset reference; and
providing information on the classified multiple requests allowing sets such that multiple requests are performed on one of the classified multiple requests allowing sets.

11. The method of claim 10, wherein the classifying comprises classifying nodes in a one-hop relationship among the nodes, as a multiple requests allowing set.

12. The method of claim 11, wherein the multiple requests allowing set is a set of nodes, each having a different scheduling message transmission time.

13. The method of claim 10, further comprising:
selecting, by a node receiving the information on the classified multiple requests allowing sets, one of the multiple requests allowing sets based on a preset data scheduling policy, subsequent to the providing; and
transmitting, by the node receiving the information of the classified multiple requests allowing sets, a request message requesting resources for each node included in the selected multiple requests allowing sets.

14. The method of claim 13, wherein the data scheduling policy is a policy for minimizing a packet delay time.
